(19) United States
(12) Patent Application Publication
(10) Pub. No.: US 2015/0046484 A1
(43) Pub. Date: Feb. 12, 2015

(54) SYSTEM AND METHOD FOR CONSTRUCTING INFORMATION STRUCTURES FOR KNOWLEDGE INFORMATION SYSTEM MANAGEMENT AND FOR SEARCHING INFORMATION STRUCTURES FOR INFORMATION

(71) Applicant: Taek sang YOO, (US)

(72) Inventor: Taek sang Yoo, Seoul (KR)

(21) Appl. No.: 14/385,278

(22) PCT Filed: Mar. 14, 2013
(86) PCT No.: PCT/KR2013/002040

§ 371 Date: Sep. 15, 2014

(30) Foreign Application Priority Data
Mar. 15, 2012 (KR) 10-2012-0026753

(51) Int. Cl. G06F 17/30

(52) U.S. Cl. CPC G06F 17/30389; G06F 17/30289; G06F 17/30091
USPC 707/758

(57) ABSTRACT

The present invention relates to a system and method for constructing information structures for knowledge information system management and for searching the information structures for information which enables searching for desired information by constructing associations between each piece of information as a visible structure and verifying the association and the order of rank between the pieces of information from the information structure. Information objects are created by receiving data from the user. The created information objects are disposed in a space and associations between the information objects are indicated. Then, the information structure, which is an information cluster, is constructed. The information cluster includes a plurality of information objects which are stereoscopically arrayed within a location space and selectively connected to each other.

### TECHNICAL FIELD

The present invention relates to a system and a method for constructing an information structure for managing a knowledge information system and searching information from the information structure, and more particularly, to a system and a method for constructing a correlation among respective information in a visualizable structure, determining the correlation and a rank among the information from the structure of the information to construct an information structure that enables desired information to be searched, and searching information from the information structure.

### BACKGROUND ART

In a today information environment in which the amount of information explosively increases, both an importance and a difficulty in finding specific required information have increased. In particular, a method for tracking newly developed information according to an information correlation based the existing information may be used. The method corresponding to a case in which precious information is unexpectedly acquired based on an information correlation of a homepage constructed by a specialist in a specific field and the method for searching the information based on the informative correlation may be used in its way as an indirect method for supplementing a direct method such as keyword searching.

However, the informative correlation constructed by a specific person may be changed in any degree depending on a subjective viewpoint and an opinion of an information provider like such an example. Therefore, it is difficult to expect that an informative correlation which is not consistent and continuously includes information to be found is constructed and provided. In addition, the correlation should be immediately and intuitively determined for rapid searching based on the informative correlation and since the informative correlation is conceptual, the informative correlation exists only in though and when thinking is actuated in concentration on two specific pieces of information. Further, since a searcher should perform a stepwise searching process in the method for searching the information based on the correlation of the respective information, there is a problem that the searching process is complicated and a long time is required. Furthermore, when the searcher performs information searching by using a plurality of search words, since a correlation or a rank relationship among respective search words is not reflected on a search result, reliability in search result becomes a problem or there is a problem that a lot of noise is included.

### DISCLOSURE

### Technical Problem

The present invention is contrived to solve the problems in the related art and an object of the present invention is to allow a plurality of specialists in a specific field to construct various informative correlations including a considerable amount of information based on specialists' own special viewpoints and opinions and generate an information structure to visibly represent a correlation among information so as to share the informative correlations.

In addition, an object of the present invention is to allow a structure of information to be intuitively determined by visualizing a correlation or a rank relationship among information.

Furthermore, an object of the present invention is to allow users to construct an appropriate structure among information by continuously changing and updating a structure among information.

Further, an object of the present invention is to allow information which a user intends to acquire to be easily searched based on the informative correlation constructed based on a special viewpoint.

An object of the present invention is to enable deep search of information because information can be searched based on the relationship of associated information based on an informative correlation.

### Technical Solution

According to a characteristic of the present invention for achieving the objects, a method for managing data in a system that constructs an information structure for managing a knowledge information system and searching information from the information structure includes: receiving data from the user, generating an information object including the data and arranging the generated information object at a predetermined location of a 2D position space including the information structure; and setting, by the user, positional information representing a relative position of the generated information object in the position space, and association information representing a connection relationship between the generated information object and another information object, through the interface unit, arranging the generated information object in the information structure, wherein the information structure is an information aggregate including a plurality of information objects dimensionally arranged in the position space and selectively connected to each other.

According to the present invention, a method for managing data in a system that constructs an information structure for managing a knowledge information system and searching information from the information structure includes: receiving data from the user, generating an information object including the data and arranging the generated information object at a predetermined location of an nD (n is a natural number of 3 or more) position space including the information structure; and setting, by the user, positional information representing a relative position of the generated information object in the position space, and association information representing a connection relationship between the generated information object and another information object, through the interface unit, arranging the generated information object in the information structure, wherein the information structure is an information aggregate including a plurality of information objects dimensionally arranged in the position space and selectively connected to each other.

Herein, the method of the present invention may further include: arranging, by the user, a duplicated structure at the predetermined location of the position space when a partial or the entire structure of another information structure from another position space is duplicated; and setting, by the user, positional information representing a relative position of the duplicated structure in the position space from the another position space, and association information representing a connection relationship between an information object included in the duplicated structure from the another position space and the information object of the information structure, arranging the information object included in the structure duplicated from the another position space in the information structure.

In addition, the method of the present invention may further include arranging the information object included in the structure duplicated from the another position space in the information structure and thereafter, tagging user information in which the another information structure is constructed in the another position space to the information structure.

Moreover, the method may further include performing, when any one command of deletion, positional change, association change, and data modification of any one information object included in the information structure is input from the user, any one of the deletion, the positional change, the association change, and the data modification of any one information object according to the command to update the information structure.

Further, the method of the present invention may further include selecting, by the user, any one information object included in the information structure and additionally generating another position space commonly including the selected information object and subordinate to a location of the selected information object in the position space.

In addition, in the present invention, a position space including a predetermined information structure may be divided into a position accessible by only the user, a position space accessible by only another user, and a position space accessible by all users including the user and another user.

Furthermore, in the present invention, a connection relationship between a predetermined information object and another information object may be represented by a connection line for connecting the predetermined information object and another information object to each other.

Further, the method of the present invention may further include searching and displaying, by the user, when two or more associated search words are input, an information structure including information objects corresponding to input search words, respectively and in which the information objects corresponding to the input search words, respectively have a similar association as the search word.

In this case, the displaying of the search result through the interface unit may include analyzing association information between input search words and information objects corresponding thereto, respectively and when the input search words and the information objects corresponding thereto, respectively are directly connected to each other or directly connected via another information object within a predetermined limited range, searching an information structure having a similar association as an input search word.

In addition, when two or more search words are vertically associated with each other, the positional information of the information objects corresponding to the input search words, respectively is analyzed to search only an information structure in which an information object corresponding to a relatively upper-level search word is positioned above an information object corresponding to a relatively lower-level search word as an information structure having a similar association as the input search word.

In this case, when two or more search words are horizontally associated with each other, the positional information of the information objects corresponding to the input search words, respectively is analyzed and the information objects corresponding to the input search words, respectively may be searched as the information structure having the similar association as the input search word when the information objects corresponding to the input search words, respectively are directly connected to each other or directly connected through another information object via another information object within a predetermined range even though input orders of the search words and a connection order of the information objects are different from each other.

In addition, the searching and displaying of the information structure may further include: receiving two or more search words from the user, selecting, by the user, a restriction of at least one of a pattern, an order, and a distance of the association among the information objects corresponding to two or more search words, respectively, and searching an information structure including the information objects corresponding to the input search words, respectively and having an association corresponding to any one restriction among a pattern, an order, and a distance of the information objects corresponding to the input search words, respectively selected by the user and displaying the search result, and the pattern of the association may include a horizontal pattern, a vertical pattern, and a complex pattern having horizontal and vertical patterns.

Further, the method of the present invention may further include searching and displaying, when two or more search words are input from the user, an information structure in which at least some of the information objects corresponding to the input search words, respectively coincide with the input search word.

Meanwhile, according to the present invention, a system for constructing an information structure including a plurality of information objects dimensionally arranged in a 2D position space and selectively connected to each other, and searching information from the information structure to manage data includes: an interface unit configured to communicate with a user and receive data from the user; a control unit configured to generate an information object including the data by receiving the data from the interface unit and arrange the generated information object in a position space including the information structure; and a storage unit configured to store one or more information structures including the information structure with the generated information object, wherein the user interface unit is configured to receive positional information and association information of the generated information object from the user and the control unit is configured to arrange the generated information object in the information structure by referring to the positional information and association information of the generated information object.

Further, according to the present invention, a system for constructing an information structure including a plurality of information objects dimensionally arranged in an nD (n is a natural number of 3 or more) position space and selectively connected to each other, and searching information from the information structure includes: an interface unit configured to communicate with a user and receive data from the user; a control unit configured to generate an information object including the data by receiving the data from the interface unit and arrange the generated information object in a position space including the information structure; and a storage unit configured to store one or more information structures including the information structure with the generated information object, wherein the user interface unit is configured to receive positional information and association information of the generated information object from the user and the control unit is configured to arrange the generated information object in the information structure by referring to the positional information and association information of the generated information object.

Herein, the interface unit is also configured to receive two or more associated search words from the user, and the control unit is configured to search an information structure including information objects corresponding to input search words, respectively and in which the information objects corresponding to the input search words, respectively have a similar association as the search word, from the storage unit to display the search result to the user through the interface unit.

Further, the control unit may store, in generating, an information object, data to be included in the generated information object in a third-party server provided to communicate with the system through a network and store positional information and association information of the generated information object in the storage unit.

### Effect of the Invention

According to the present invention having such a configuration, an information structure can be generated, which can visibly a correlation among information so as to construct various informative correlations and share the informative correlations.

Further, according to the present invention, a structure of information can be intuitively determined by visualizing a correlation or a rank relationship among information.

In addition, according to the present invention, users are allowed to construct an appropriate structure by continuously changing and updating the structure among the information.

Moreover, information which a user intends to acquire to be easily searched can be easily searched based on the informative correlation constructed based on a special viewpoint.

Further, deep search of information is enabled because information can be searched based on the relationship of associated information based on an informative correlation.

### DESCRIPTION OF DRAWINGS

FIG. 1 is a conceptual diagram illustrating a configuration of a system for constructing an information structure and searching information from the information structure according to an embodiment of the present invention.

FIG. 2 is a block diagram illustrating a configuration of an information structure management system of the system for constructing an information structure and searching information from the information structure according to the embodiment of the present invention.

FIG. 3 is a schematic diagram illustrating information structure sharing in the system for constructing an information structure and searching information from the information structure according to the embodiment of the present invention.

FIGS. 4 to 6 are exemplary diagrams illustrating a type of the information structure according to the embodiment of the present invention.

FIG. 7 is an exemplary diagram illustrating an example of space extension of an information structure in a method for constructing an information structure according to an embodiment of the present invention.

FIG. 8 is a flowchart stepwise illustrating the method for constructing an information structure according to the embodiment of the present invention.

FIG. 9 is an exemplary diagram illustrating an example of copying and adding a partial structure of the information structure in the method for constructing an information structure according to the embodiment of the present invention.

FIG. 10 is a flowchart stepwise illustrating a method for searching information by using an information structure according to an embodiment of the present invention.

FIGS. 11 to 14 are exemplary diagrams illustrating an example of searching information by using an associated search word in the method for searching information by using an information structure according to the embodiment of the present invention.

FIG. 15 is an exemplary diagram illustrating an example of generating an information object through linkage with a third-party server in the method for constructing an information structure according to the embodiment of the present invention.

### BEST MODE

Hereinafter, embodiments of the present invention will be described with reference to the accompanying drawings, but the present invention is not limited thereto. Like reference numerals are used to represent like elements.

The present invention allows the structure of information to be displayed so as to take a glance and the display to be changed, by using a visible virtual space provided in electronic devices (for example, a smart phone, a portable terminal, and the like). That is, in the present invention, a user converts a conceptual relationship (correlation, a correlation degree, or a rank) among information a spatial relationship into a spatial relationship (a distance or a vertical position, and an inter-space inclusion relationship) through the electronic devices to attempt intuitively determining a correlation among the information and finding a meaningful structure among the information. For example, since the user may view the structure among the information at a glance in implementing the present invention, the user may easily determine a relation among the information according to intuition and information having a high relation may be arranged to be adjacent to each other or arranged according to the rank among the information to find new information which the user intends to search from the structure of the arranged information.

Further, in the present invention, a dimensionally constructed virtual position space may be extended to n (n is a natural number) dimensions, and information or a part of the structure of the information is transfer/replicated to another position space between dimensions or information may be exchanged among position spaces of other dimensions, and as a result, the structure of the information may be configured and managed by constructing an independent position space for each dimension. The correlation of the information is displayed in the dimensional virtual position space through structuralization and visualization to visually express all of complicated associations among the information. The present invention will be described below by using a 3D position space as an example, but the present invention is not limited thereto and the position space may be formed in n dimensions and respective divided position spaces may have different dimensions.

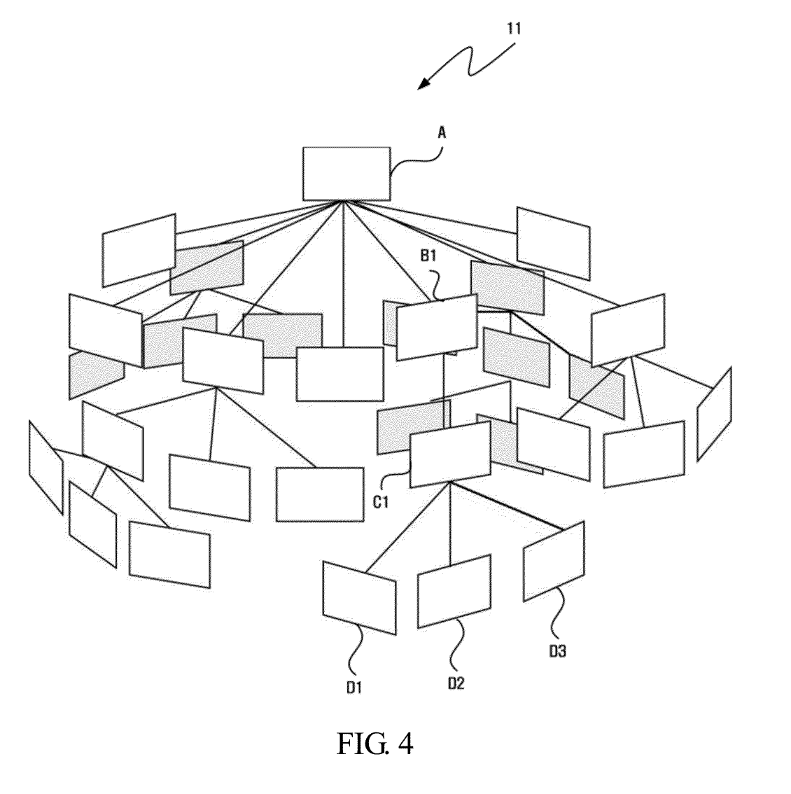

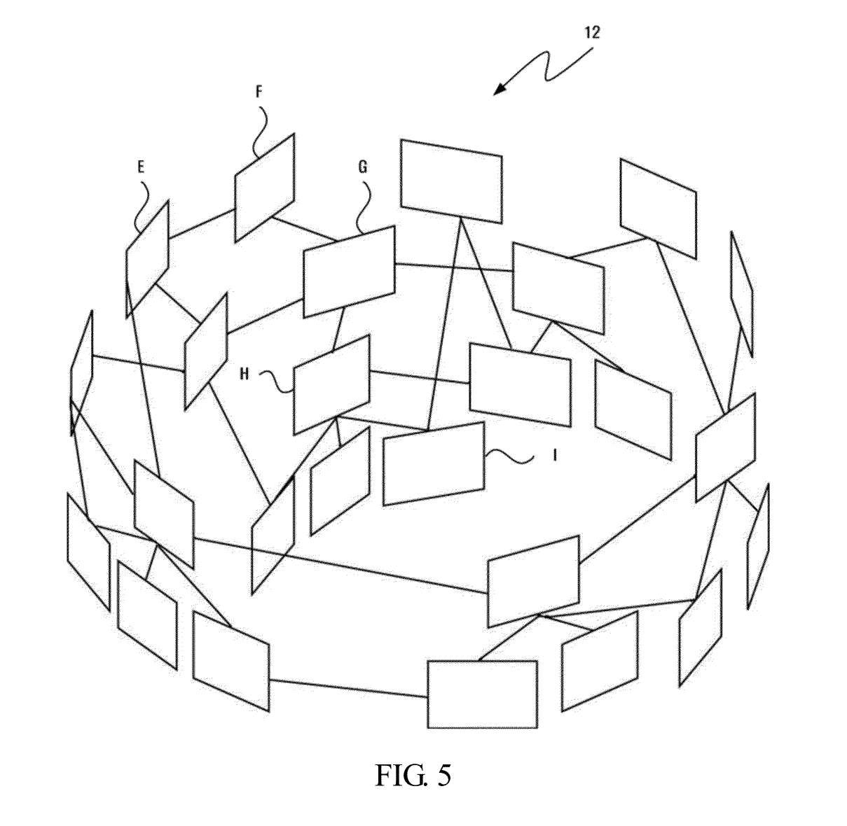

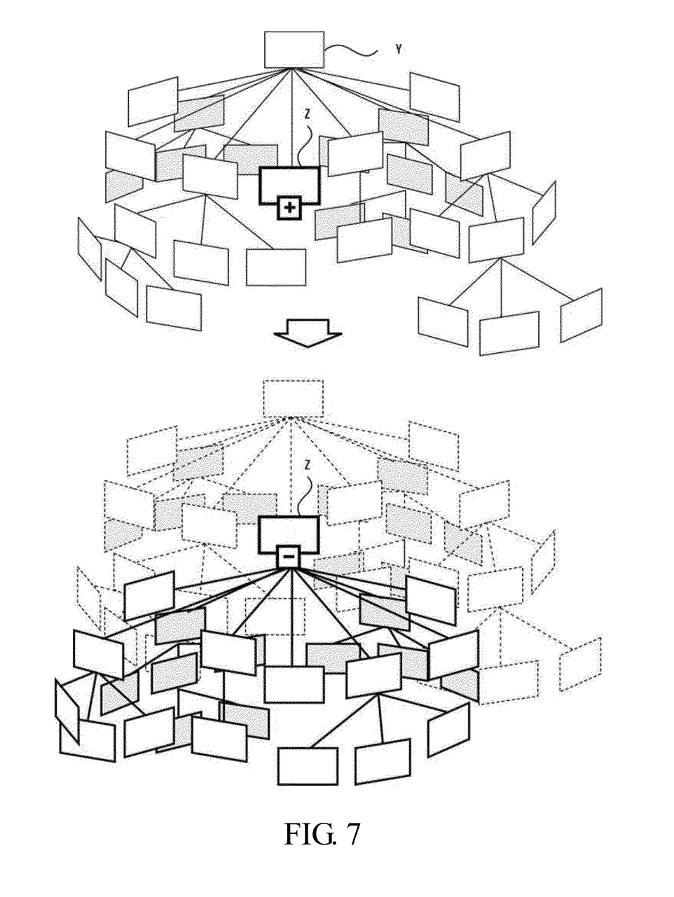

The following terms are defined, before describing preferred embodiments of the present invention. In the specification, ‘data’ means a term acquired by processing information which is a conceptual term to be managed in the system, and the data may include texts, images, audio, and the like, and may include, in particular, a document (a web page, and the like) or a file for representing the information, or the position of the file, or the like. Further, an ‘information object’ is an object that visualizes the data to a user. The information object may have, for example, a note shape as illustrated in FIGS. 4 to 6 and may be visualized to the user in a form in which data is represented on the note. However, when the data is not visible data such as the text or the image or is difficult to represent on the note like the file or the web page, the data may be represented in a form of a thumbnail of the file or the web page or expressed in a form in which a file name is written on the note. Further, in the specification, an ‘information structure’ means an information aggregate having a dimensional structure, which is configured by arranging a plurality of information objects in the virtual space by considering whether data expressed by the information object are correlated or a correlation degree of the data, a vertical rank or an inclusion relationship of the data. In addition, in the specification, a ‘position space’ as a virtual space in which the information structure is positioned is displayed in the electronic device and coordinate information representing the location of the information object in the position space is given to each information object. Of course, the ‘position space’ may virtually exist even in an nD extended space and for example, a position space of FIG. 7 is configured in 3D, but an information structure which subordinates to an information object ‘Z’ is formed in a separate position space, and as a result, respective information objects included in an information structure displayed below the information object ‘Z’ are positioned in a separate 3D space which is newly formed below one spot on the 3D space where the information object ‘Z’ exists and the newly generated position space conceptually corresponds to a 6D space. In drawings of the present invention, the newly generated position space is illustrated as the 3D position space, but when the newly generated position space is actually applied, the newly generated position may become a 1D linear space or a 2D plane space. As described above, in the present invention, the position space in which the information structures are positioned may be ultimately extended to an nD space. Human spatial perception is limited to the 3D space, but on a program, new independent coordinate values are associated below a coordinate value representing a specific spot in a specific space to extend and manage the dimension of the space.

Meanwhile, ‘positional information’ means the positions of the respective information objects in the position space and the positional information may include coordinate values representing relative location of the information objects in n dimensions. Further, ‘association information’ as information representing the connection relationship among the respective information objects may be information on another information object connected with a predetermined information object. For example, in FIG. 5, association information of an information object ‘F’ may include identifiers of information objects ‘E’ and ‘G’.

Meanwhile, a ‘connection line’ as a line represented to connect the respective information objects included in the information structure may be represented like a straight line that links the information object ‘A’ and the information object 131′ in FIG. 4, but the present invention is not limited thereto and may be represented by various forms including a curve, and the like as necessary. The connection line as a line that connects two information objects represents a correlation between two information objects connected by the connection line. For example, a connection line that directly connects information objects ‘D1’ and ‘D2’ is not represented in FIG. 4 and this represents that the information objects ‘D1’ and ‘D2’ has no direct correlation and the information objects ‘D1’ and ‘D2’ are directly connected by two connection lines via an information object ‘C1’. Further, the length of the connection line itself may represent a correlation degree between the connection information objects and in this case, the length of the connection line may be stepwise controlled to be integer times larger than a predetermined unit length. Alternatively, a correlation degree between two information objects among a plurality of information objects which are directly or indirectly connected through the connection line may be determined by the number of connection lines included in a path including the smallest number of connection lines among one or more paths that link two information objects.

Hereinafter, a system and a method for constructing the defined information structure and searching information by using the constructed information structure will be described in more detail.

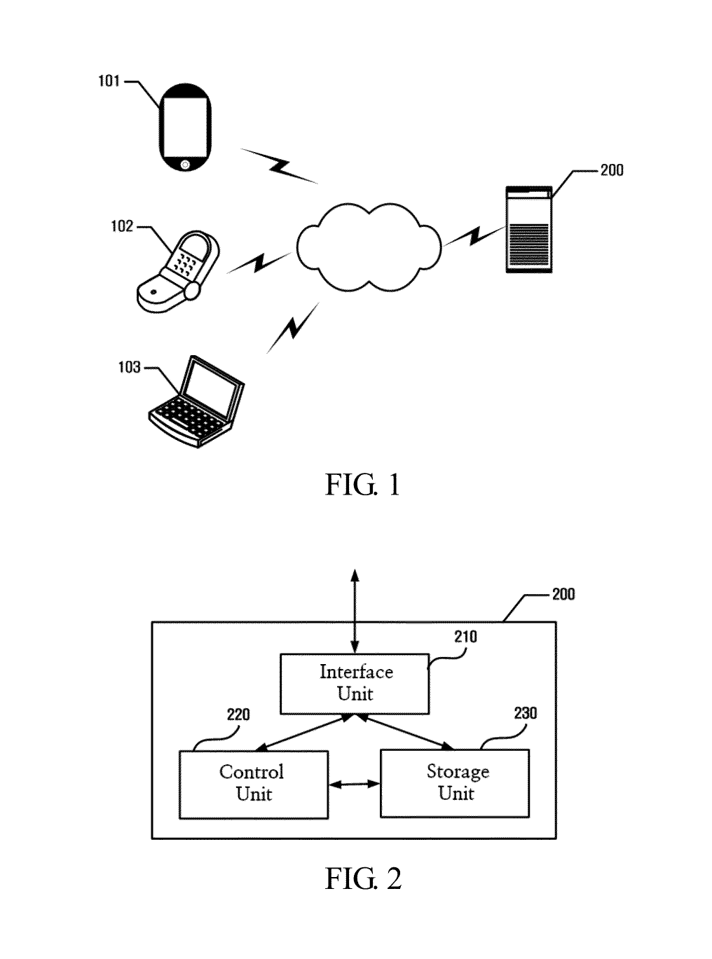

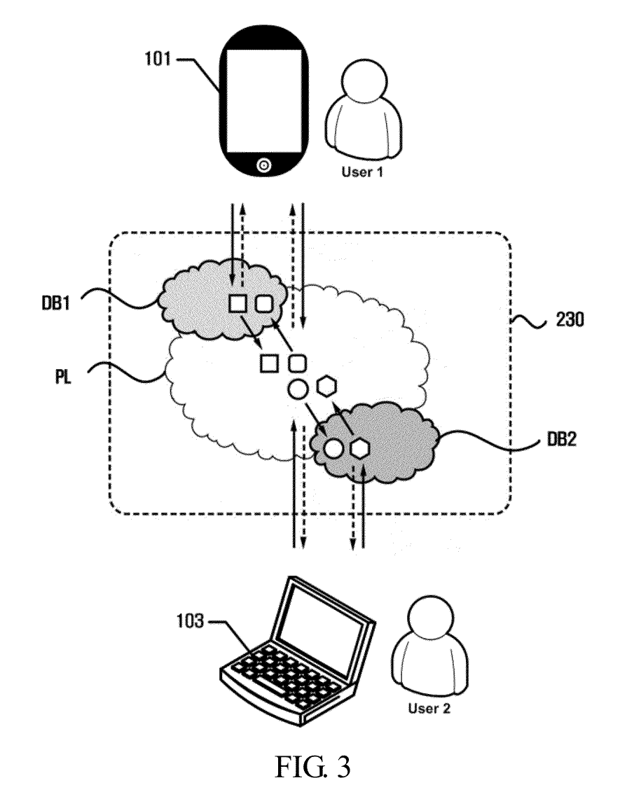

FIG. 1 is a conceptual diagram illustrating a configuration of a system for constructing an information structure and searching information from the information structure according to an embodiment of the present invention. FIG. 2 is a block diagram illustrating a configuration of an information structure management system of the system for constructing an information structure and searching information from the information structure according to the embodiment of the present invention. FIG. 3 is a schematic diagram illustrating information structure sharing in the system for constructing an information structure and searching information from the information structure according to the embodiment of the present invention. FIGS. 4 to 6 are exemplary diagrams illustrating a type of the information structure according to the embodiment of the present invention. In addition, FIG. 7 is an exemplary diagram illustrating an example of space extension of an information structure in a method for constructing an information structure according to an embodiment of the present invention.

In FIG. 1, terminals 101, 102, and 103 as electronic devices which are capable of communicating with a user and processing information may include a personal computer (PC), a mobile communication terminal, personal digital assistants (PDA), a smart phone, a notebook computer, a tablet computer, and the like. The terminals 101, 102, and 103 display a virtual space including an information structure on a display to allow users to check a structure of associated information.

In addition, an information structure management system 200 as a system that supports construction of the information and search of information through the information structure by a user is a system that allows information in various fields to be associated with each other to structuralize and manage the corresponding information. The information structure management system 200 is communication-connected with the terminals 101, 102, and 103 through a network to be accessed by the user, and may be include the terminals 101, 102, and 103 or be included in the terminals 101, 102, and 103, and may operate in link with an application program for information management, is installed in the terminals 101, 102, and 103.

The information structure management system 200 includes an interface unit 210, a control unit 220, and a storage unit 230 that perform functions which are described below, respectively. The components are capable of communicating with each other and may be implemented by different hardware systems, respectively, and may be physically implemented as a software module that performs inter-process communication in one system.

The information structure management system 200 may communicate with the user through the interface unit 210 and include an output unit (not illustrated) that allows the information structure to be displayed to the user and an input unit (not illustrated) that receives data to configure the information structure from the user. It may be appreciated by those skilled in the art that the interface unit may be provided through various methods that enable interaction between the user and the system.

When the information structure management system 200 receives data input by the user through the interface unit 210, the information structure management system 200 generates an information object corresponding to the input data through the control unit 220. The control unit 220 arranges the generated information object in a position space including an information structure selected by the user, however, receives arranged positional information from the user. Moreover, when a predetermined information object moves from a specific position space to another position space or moves to another position in the specific position space, the control unit 220 updates positional information of the moved information object. In this case, the updated positional information of the predetermined information object may be relatively determined according to positional information of other information objects. Furthermore, the control unit 220 may delete the predetermined information object or change or modify data included in the information object. Further, the control unit 220 may generate a new position space or extend the position space up to n dimensions. In addition, when associated search words are input from the user through the interface unit 210, the control unit 220 searches an information structure including associations which is the same as or similar as the input search words to transmit the searched information structure to the user through the interface unit 210 again, and as a result, the user may check the information structure displayed on the terminals 101, 102, and 103. Herein, a process of searching the information structure including the same or similar associations will be described below in more detail.

Meanwhile, the storage unit 230 stores various data required for operating the control unit 220 and the interface unit 210. That is, the storage unit 230 stores information input and output through the interface unit 210, stores the information and the information structure generated by the control unit 220, or updates the generated information object and information structure whenever the stored information is changed. Further, the storage unit 230 receives personal information and security information from users of the terminals 101, 102, and 103 to generate and store accounts of the respective users.

For example, a first database DB1 assigned to an account of a first user User 1 is assigned and a second database DB2 assigned to an account of a second user User 2 are separately provided in the storage unit 230 as illustrated in FIG. 3 and an information pool PL in which all users may share the information structure is stored in the storage unit 230. The information structures constituted by the users are stored in the databases DB1 and DB2 and the information pool PL. That is, the information structure management system 200 may enable constructing the information structure and providing a search service using the constructed information structure under a cloud computing environment.

As a result, the respective users may construct the information structure by using the terminals 101, 102, and 103 thereof to store the constructed information structure in the databases DB1 and DB2 or the information pool PL assigned thereto, access the databases DB1 and DB2 or the information pool PL assigned thereto to refer to the stored information structure, and share the information structure stored in the databases DB1 and DB2 stored therein by using the information pool PL or personalize the information structure registered in the information pool PL by using the databases DB1 and DB2 thereof. Further, the information structure management system 200 may process the information structure personalized in the databases DB1 and DB2 thereof or register the processed information structure in the information pool PL again. By such a configuration, the information structure may be individually constructed by respective persons and jointly constructed through multilateral cooperation. In addition, the structured information structure may be individually kept and managed by the persons and share multilaterally. Reliability of information may be improved in that the shared information structure may be evaluated, modified, and developed through the multilateral cooperation.

However, this is one embodiment and as another embodiment, the databases DB1 and DB2 of the respective users may be constructed in not the storage unit 230 but the terminals 101 and 103 of the respective users.

In this case, in regard to the respective information objects constituting the information structure, data, positional information of the information object, and association information included in the information object are stored in the storage unit 230. For example, when an information structure 11 is stored in FIG. 4, the storage unit 230 stores information on all respective information objects included in the information structure 11 together with identification information of the information structure 11, and information stored for an information object ‘B1’, data corresponding to the information object ‘B1’, a coordinate value in a position space of the information object ‘B1’, and another information object information (information objects ‘A’ and ‘C1’) connected with the information object ‘B1’ may be stored in the storage unit 230.

Meanwhile, when a form of the information structure is described in more detail, the information structure may be formed in various forms as illustrated in FIGS. 4 to 6. First, as illustrated in FIG. 4, a 3D inverse tree pattern information structure 11 is enabled, which has a shape in which a plurality of information objects as a lower concept extends in an inverse tree shape with one top level information object ‘A’ as an apex. The inverse tree pattern information structure 11 is formed in such a manner that the information object ‘B1’ which belongs to the lower concept in rank than ‘A’ or has data conceptually subordinate to ‘A’ is arranged relatively below ‘B1’ to be connected with the information object ‘A’ and the information object ‘C1’ which belongs to the lower concept than the data included in the information object ‘B1’ or has data conceptually subordinate to or included in the data included in the information object ‘B1’ is connected below the information object ‘A’ again. In this case, the inverse tree information structure 11 has a general pattern in which various lower information objects are associated with upper information objects as described above, and as a result, more information objects are associated as the information objects move down, but when the information objects move along information objects associated with a lower level of a predetermined information object included in one information structure, some lower information objects may be commonly associated with a plurality of upper different information objects. That is, one lower information object may have two or more upper information objects according to contents and rank relationships of the respective information objects.

Further, the information structure may become a net pattern structure 12 as illustrated in FIG. 5. When a relative rank or inclusion relationship of the information objects included in the information structure is ambiguous and a correlation among the respective information objects is irregular, the net pattern information structure 12 may be constructed. In the net pattern information structure 12, there is no inclusion relationship or rank among the respective information objects and for example, information objects ‘E’ and ‘F’ are directly correlated with each other, but ‘E’ and ‘G’ may be indirectly correlated by ‘F’ and ‘G’ and ‘T’ are correlated with a shorted path through ‘H’. As a result, in the case of even data which are not directly correlated, concepts which are closely correlated with each other may be checked according to the number of connection lines included in the correlated shortest path and in this case of information objects having a relatively lower correlation, the number of connection lines included in the correlated path increases. That is, a correlation degree among data may be determined through a structure in which the respective information objects are connected.

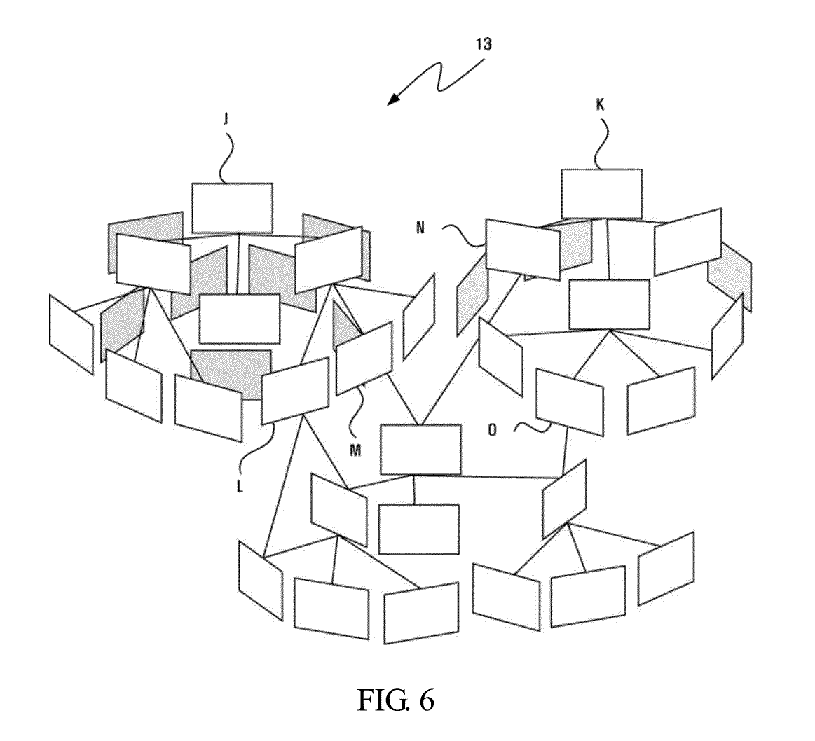

Furthermore, as illustrated in FIG. 6, a plurality of inverse pattern information structures share some information objects with each other or some inverse pattern information structures are connected in a net pattern to form a complex pattern information structure 13.

Meanwhile, one information structure may extended to another dimension as already described. The information structure is dimensionally configured in the position space in order to efficiently display the correlation among the respective information objects and when the structure of the information structure is complicated, and as a result, it is difficult to represent all of the correlations among the respective information objects or the size of the information structure itself significantly increases, the information structure extends in a higher dimension to display a partial structure constituting a part of the information structure in another dimension. In the inverse tree pattern information structure formed around an information object ‘Y’ as illustrated in FIG. 7, when the number of the associated information objects is large, and as a result, it is difficult to visibly express more information objects or when a series of information objects which is not related with other peripheral information objects intend to be disposed in association with a predetermined information object, a new independent position space is generated in the existing position space to dispose a new information object therein.

Alternatively, herein, for example, a coordinate area corresponding to 6 dimensions are fundamentally assigned at the time of constructing the existing information structure, however, each of the information objects uses only three coordinates of six coordinates and uses residual coordinates in which 0 is written and thereafter, when the dimension of the information object intends to be extended or a series of new independent information objects are correlated with the predetermined information object included in the existing information structure, different numerical values are given to even three residual coordinates to achieve an effect in which the dimension of the information structure is extended. Alternatively, all information structures are fundamentally constructed in a position space having a significantly high (for example, 9 dimensions or higher), however, only coordinates of some ciphers among coordinates of a plurality of ciphers are used according to selection by the user or as necessary in respect to a specific information structure and thereafter, when the quantity of information objects included in the information structure increases, the number of ciphers which are sequentially used as large as required may also increase when the quantity of the information objects included in the information structure increases.

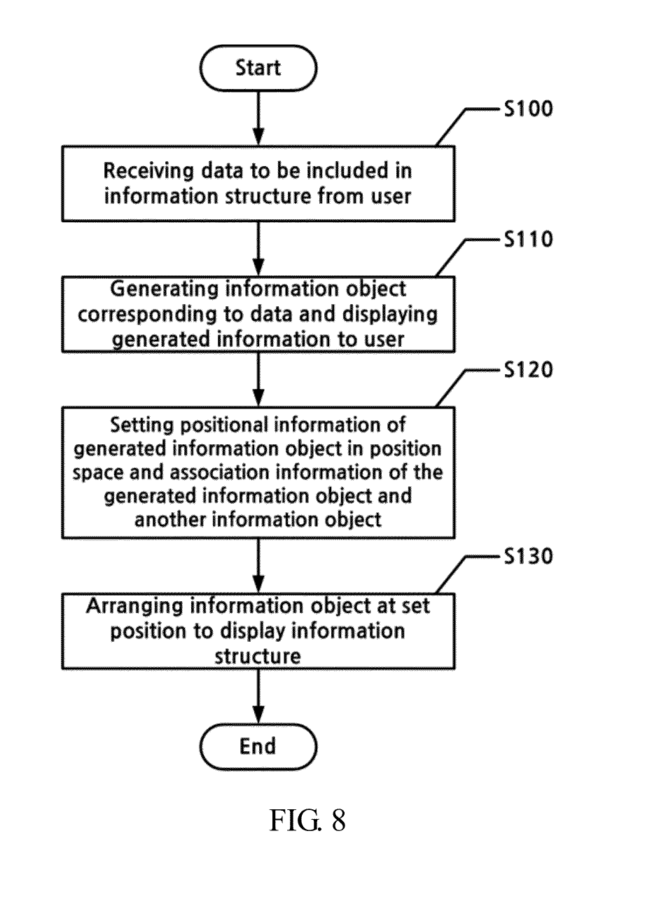

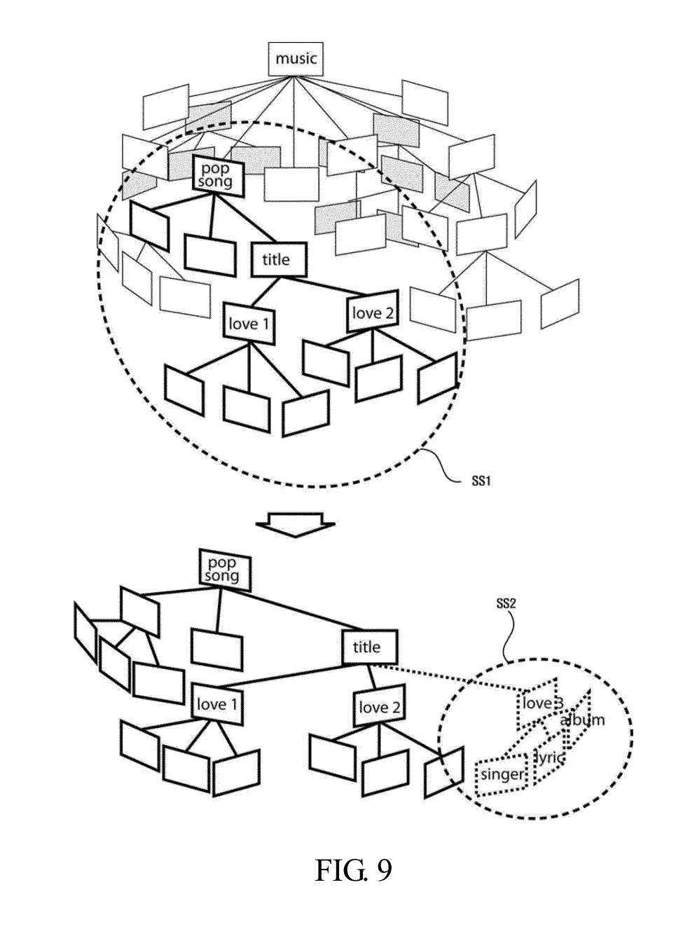

Hereinafter, the method for constructing the information for managing a knowledge information system and constructing the information structure for managing the knowledge information system by using a system that searches information from the information structure will be described in more detail. FIG. 8 is a flowchart stepwise illustrating the method for constructing an information structure according to the embodiment of the present invention. FIG. 9 is an exemplary diagram illustrating an example of copying and adding a partial structure of the information structure in the method for constructing an information structure according to the embodiment of the present invention.

In the embodiment of the present invention as illustrated in FIG. 8, the information structure management system 200 receives data to configure an information structure from the terminals 101, 102, and 103 through the interface unit 210 (S100). This is achieved when a user selects or inputs specific data and transmits the selected or input data to the information structure management system 200.

In addition, the control unit 220 visually generates an information object corresponding to the input data and transfers the visually generated information object to the terminals 101, 102, and 103 and the terminals 101, 102, and 103 display the transferred information object on a screen to allow the user to check a newly generated information object (S110).

As a result, the user may arrange the displayed new information object at a desired position and connect the new information object with another information object through a connection line. That is, the user sets correlation information between positional information of the new generated information object and another information object (S120).

Therefore, the information structure management system 200 records positional information of an information object disposed by the user in the information structure and displays the recorded positional information on the terminals 101, 102, and 103 (S130).

In the process of constructing the information structure, the user never fail to input new data not to generate the information object and as illustrated in FIG. 8, a partial structure SS1 included in another information structure which has been already constructed is coped to be included in an information structure in another position space and the new information object may be added to the partial structure SS1 or another structure SS2 which is referred to from yet another information structure may be merged.

That is, when users construct the information structure, as long as some searched information structures are copied or modified to be kept, managed, and shared in an information structure thereof, and as a result, positive change and development of the information structure may be induced. Further, by such a process, when there is an error or leap in correlation among the respective information objects of the information structure, the error or leap may be amended through modification processes by more users.

Optionally, information on the user which constructs the information structure may be tagged in the respective information structures and when another user constructs the new information structure by copying or modifying a predetermined information structure afterwards, a constructor information tag of an original information structure is tagged to even the new information structure to prevent indiscriminate information from being copied, distorted, misused, and the like and protect an intellectual property of an original constructor. Further, constructor information of an original information structure is tagged to the modified information structure, and as a result, searchers that search the new information structure is able to search an original information structure together by using an original constructor information tag tagged to the new information structure to correlationally search related information.

In addition, the users may update the information structure by performing deletion and a positional change of the information object included in the information structure, a change in connection relationship with another information object, or modification of data included in the information object.

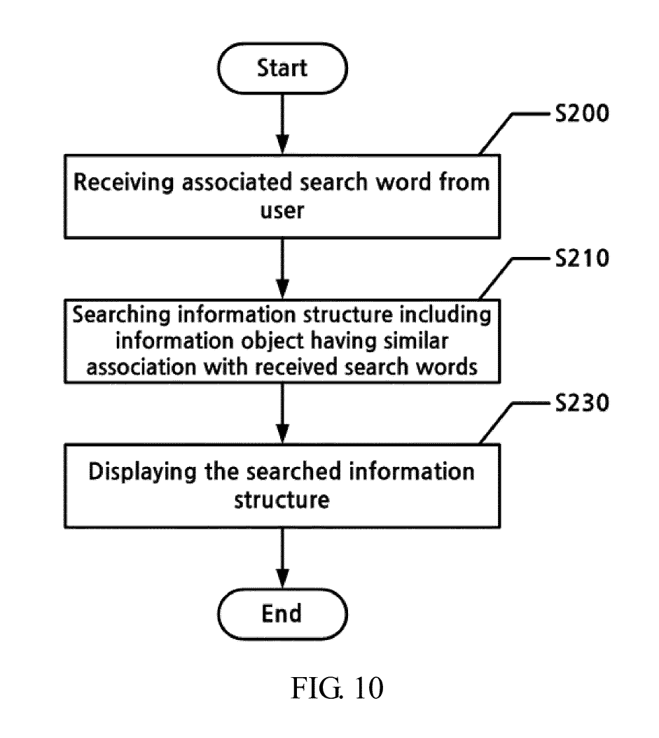

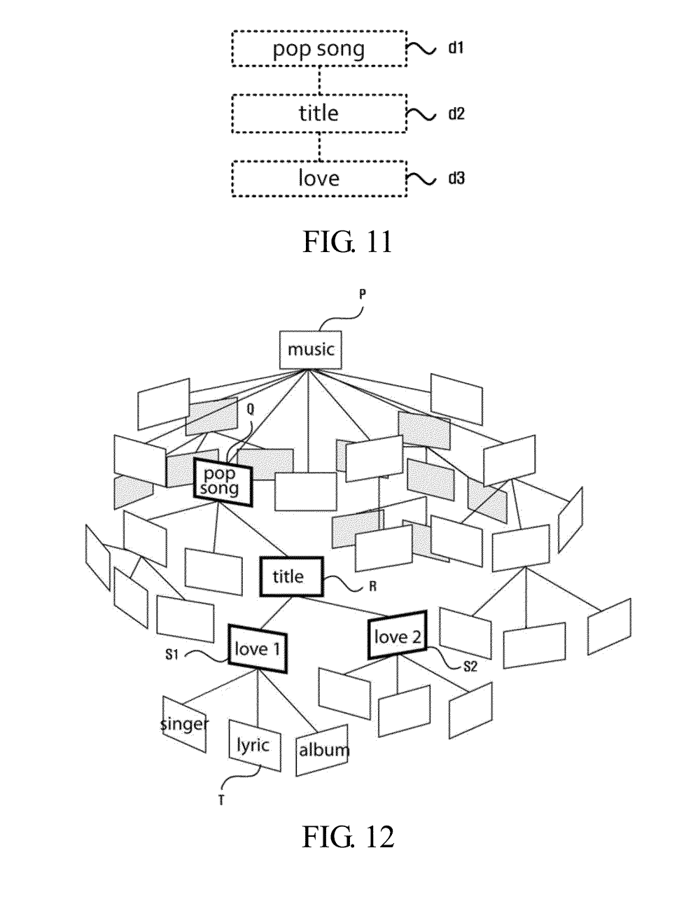

Meanwhile, a process of searching information by using the constructed information structure will be described. FIG. 10 is a flowchart stepwise illustrating a method for searching information by using an information structure according to an embodiment of the present invention. FIGS. 11 to 14 are exemplary diagrams illustrating an example of searching information by using an associated search word in the method for searching information by using an information structure according to the embodiment of the present invention.

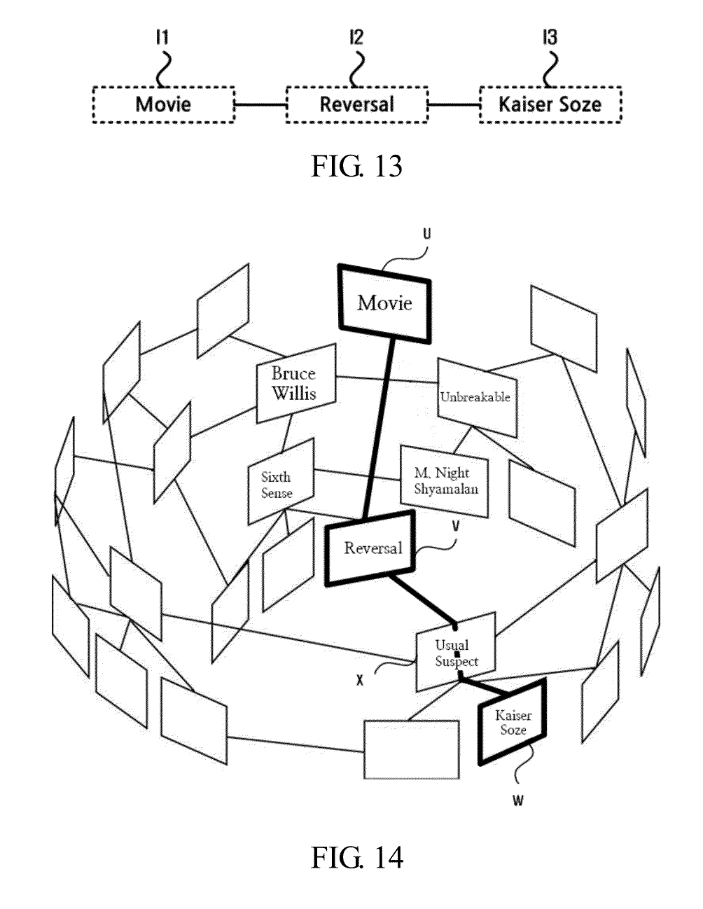

For the information searching using the information structure, first, two or more associated search words are input from the user (S200) as illustrated in FIG. 10. To this end, the information structure management system 200 may provide two or more search word input windows illustrated in FIG. 11 or 13 to the terminals 101, 102, and 103 in order to receive a plurality of search words having a correlation with each other by a vertical relationship or a horizontal relationship. As illustrated in FIG. 11, a plurality of input windows d1, d2, and d3 arranged vertically to each other may be provided so as to receive search words having a vertical rank to each other and as illustrated in FIG. 13, a plurality of input windows l1, l2, and l3 arranged horizontally to each other may be provided so as to receive a plurality of search words having a horizontal relationship to each other.

In addition, when the user inputs associated search words in an input window, the control unit 220 accesses the storage unit 230 to search an information structure including information objects having the same or similar association (S210). That is, a primary search process of receiving a search word from an information searcher and searching a related information structure is performed. A highlight during such a process is not directly finding an information object to be found but preferentially finding an information structure having a high possibility to include the information object to be found. As a result, an association around searched information objects is together searched in addition to simultaneously finding other information objects having an association with an information object to be searched through a search word.

For example, when ‘pop song’, ‘title’, and ‘love’ having a vertical association are input as illustrated in FIG. 11, an information structure including an information object having such an association is searched as illustrated in FIG. 12. That is, an information structure is searched, which includes a series of information objects having ‘pop song’ at an upper level, ‘title’ at a lower level, and ‘love’ at a lowermost level as data. In this case, when information objects corresponding to the respective search words need not particularly directly connected to each other and ranks of the information objects are the same as each other, although other information objects are included thereamong, the information objects may be searched. For example, although information objects including data ‘R&B’ representing a music genre are arranged between information objects ‘Q’ and ‘R’ in the information structure illustrated in FIG. 12, the corresponding information structure may be searched. However, distances (may be defined as the number of other information objects included among information objects or the number of connection lines that connect the information objects) among information objects corresponding to the respective search words are limited and searched to limit a search quantity and improve reliability of a search result.

In addition, as another example, when ‘movie’, ‘reversal’, and ‘Kaiser Soze’ having the horizontal association are input as illustrated in FIG. 13, the search words may be searched without considering a vertical rank in the inverse tree pattern information structure, but the search words may be searched in a net pattern information structure illustrated in FIG. 14. An information structure may be searched, which just includes information objects corresponding to a series of search words input by the user according to the order of the input search words (in some embodiments, although the order is changed, the information objects may be searched). Even in the net pattern information structure, the distances (may be defined as the number of other information objects included among the information objects or the number of connection lines that connects the information objects and in some embodiments, may be defined as the distance between the information objects or the length of the connection line, which is calculated through positional information of the information object) among the information objects corresponding to the respective search words may be limited.

Furthermore, upon searching the information, after searching is performed with only a search word without designating ranks among search words, the ranks among the search words may be designated afterwards by a means for decreasing a range of searching in order to find an appropriate information structure among a plurality of searched information structures.

Further, the information need not particularly be searched by clarifying the rank or the association as illustrated in FIG. 11 or 13 and although the rank or the association does not coincide with the rank or the association among the search words, an information structure having a rank or association similar thereto may be searched and provided. That is, although the associations among the search words and the associations among the information objects corresponding to the search words, respectively completely coincide with each other, when only some thereamong coincide with each other, the information structure may be searched and although the search words which are vertically or horizontally associated are input, searching may be performed without distinguishing the vertical association and the horizontal association. For example, when searching is performed by using two or more search words having a horizontal association, an information structure in which information objects similar to the search word are vertically associated may be presented as a search result and when searching is performed by using three or more search words having a horizontal association, an information structure having a complex association in which some of them are vertically associated and residual search words are horizontally associated may also be searched and although searching is performed by using two or more search words having the vertical association, an information structure in which similar information is horizontally associated may be presented as the search result. Further, although the order of horizontal or vertical associations of input search words is partially different from an association order of the information object similar to the search word, the corresponding information structure may be presented as the search result. Different associations of the search words are reflected on the search result, however, when an information structure having another association which does not coincide with the association but similar to of the search word is searched, the searched information structure may be presented as the search result in order to extend the search range. Further, when a plurality of search words having the complex association in which some are vertically associated and the residual search words are horizontally associated is input, although the information objects similar to the search words are just vertically associated or horizontally associated, the information structure may be provided as the search result.

Furthermore although the information objects similar to the plurality of search words which are vertically or horizontally associated are not directly associated with each other but directly connected with each other through some other information objects, when it is determined that the information objects and the search words are somewhat adjacent to each other, the corresponding information structure may be reflected on the search result. Further, only when information objects determined to be similar to all respective input search words are all associated with each other within a specific range, the search result may be displayed. In addition, although all of the information objects determined to be similar to the respective search words are not particularly associated with each other, even when it is determined that all of the information objects are arranged within a predetermined distance range, the information structure may be reflected on the search result.

Further, the search result may be sequentially displayed from an information structure having an association which is most similar to the association among the input search words to an information structure having a lowest similar association. As a result, the user first verifies an information structure having an association which coincides with of an association of search words input by the user himself/herself, however, information structures having a similar association may be at least referred even though the information structure having the same association is not present to prevent the search range of the information from being limited.

Various search options may be provided to the user so as to allow even the information structure in which the association of the search words and the association of the information objects corresponding to the search words, respectively do not completely coincide with each other to be included in the search result. Whether to allow only the information structure with the association which is the same as the association among the input search words to be included in the search result or even another information structure including the similar association to be included in the search result may be selected by the user. Further, at least some of association methods, that is, the horizontal association, the vertical association, and the complex association are selected by the user to search only the information structure in which the information object is associated according to the selected methods. In this case, if all of three methods are selected, only when the information objects corresponding to the search words are connected to each other regardless of the association methods, all of the cases may be included in the search result. Further, in order to allow even the case in which the information objects corresponding to the search words are not directly associated but indirectly associated to be included in the search result, what distances between the respective search words and the similar information objects from the user are limited may be separately input. Further, whether to just reflect the association order of the search words even on the search result may be selected. That is, for example, when search words A, B, and C are input, whether to limit an association order of information objects corresponding to the search words A, B, and C, respectively to A-B-C or whether to allow even changed orders including A-C-B, and the like to be included may be verified by the user.

That is, in searching the information structure by receiving two or more search words from the user, a pattern (horizontal, vertical, or complex pattern) among the information objects corresponding to the respective search words, limitations for the order of the association, the distance of the association, when the information objects are indirectly associated with each other, the distance of the association, and the like are selected as options to provide an information structure corresponding thereto as the search result.

Herein, the information structure may be searched by searching one or more information objects including the respective input search words or similar words to the search words as data and searching an information object including different search words or similar words to the search words as data within set distances among the information objects and extracting an information structure including the information objects. To this end, similar words or related words to respective words to become the search words may be stored in the storage unit 230.

Then, the control unit 220 allows the information structure searched through the interface unit 210 to be displayed on the terminals 101, 102, and 103 to allow the user to visually verify the searched information structure. In this case, the information objects corresponding to the input search words may be distinguished and displayed and the information objects are displayed on the front of a screen to allow the user to immediately verify the search result. As a result, a secondary search process is performed, in which the user searches a specific information object including desired information according to an informative association of the information objects in the information structure while verifying the information objects corresponding to the search words input by the user and information objects arranged therearound one by one.

As a result, in the case where the user intends to find lyrics of a pop song having a title of ‘love’, when the associated search word is input as illustrated in FIG. 11 as compared with the case in which the pop song including the word of ‘love’ in the lyrics is searched as an excessive quantity of noise items by the existing general search method of inputting ‘love’, ‘pop song’, and ‘lyrics’ as keywords, the information structure having an association (information object ‘Q’-‘R’-‘S1’) similar to the input search word is searched as illustrated in FIG. 12, and as a result, ‘pop song’ having ‘love’ as ‘title’ is searched and an reassociated information object ‘T’ is verified, and as a result, desired lyrics may be found. Further, in the case where the user intends to verify a title of ‘movie’ having a ‘reversal’ story, in which a main character ‘Kaiser Soze’ appears, when searching is performed by inputting the titles as the search words as illustrated in FIG. 9c, an information structure illustrated in FIG. 14, which includes a series of information objects ‘U’, ‘V’, and ‘W’ having an association similar thereto is searched and the user visually verifies the searched information structure to verify a movie title through the information object ‘X’ including the information desired thereby and verify other peripheral information together.

That is, the user may search related information structures by inputting associated search words and visually verifies the searched information structures in the 3D space to verify both a search result desired by the user and other associated peripheral information through the association among the information objects, thereby discovering new unexpected beneficial information and a series of associated information is simultaneously acquired, thereby decreasing the number of search times and achieving an in-depth consideration of the associated information.

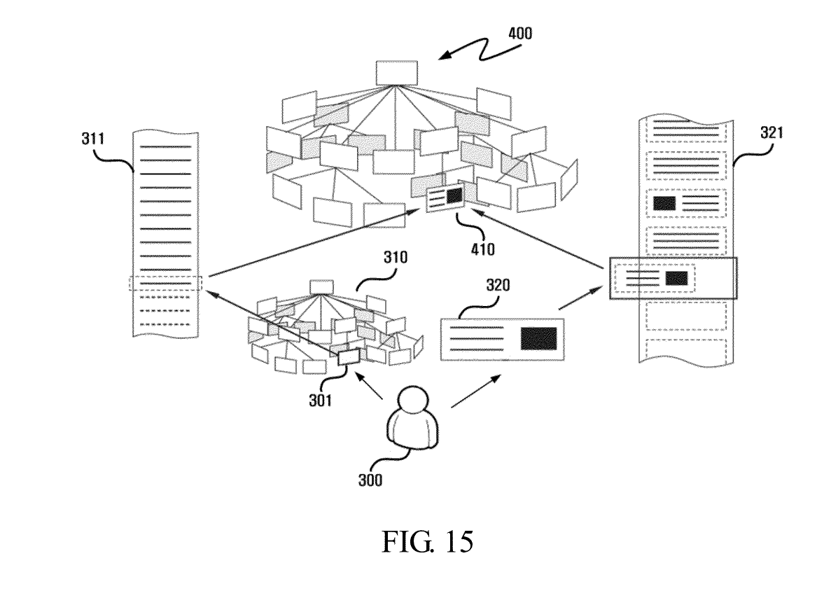

Meanwhile, data included in the respective information objects constituting the information structure, positional information of the information object, and association information may be stored in different databases. FIG. 15 is an exemplary diagram illustrating an example of generating an information object through linkage with a third-party server in the method for constructing an information structure according to the embodiment of the present invention.

For example, as illustrated in FIG. 15, in an information structure including an information object 410, data 320 included in the information object 410 is stored in the third-party server 321 and positional information and association information 301 are stored in another database 311 storing the positional information and the association information, through linkage with a third-party server 321, for example, a server providing a social network service by using an open application programming interface (API), and the like. In this case, location information regarding a location in which the data 320 to be included in the corresponding information object 410 is stored in the third-party server 321 may be stored in the database 311 together the positional information and association information 301 of one same information object 410. Therefore, the information object 410 included in the information structure 400 and including rank information, positional information, and data stored in different databases is displayed to a user 300.

This may distribute a burden of the server for storing and managing the information structure to a plurality of databases and set a connection relationship among data stored in the third-party server storing data by adopting an information structure provided in another server without information on an association relationship.

It may be appreciated by those skilled in the art that various exemplary logic blocks and algorithm steps described in association with the embodiments disclosed herein may be implemented electronic hardware, computer software, or a combination thereof. In order to clearly describe the replaceability of hardware and software, various exemplary steps have been described in detail primarily in terms of functions thereof. Whether the functions are to be implemented by the hardware or the software depends on specific applications and design restrictions given to the entire system.

Those skilled in the art may implement the described functions in various methods for respective specific applications, but should not appreciate that determination of the implementation is out of the scope of the present invention. That is, the embodiments are just examples for describing the present invention in detail and the present invention is not limited to the embodiments. Addition, omission, substitution, and other changes can be made in the scope without departing from the spirit of the present invention. The present invention is not limited to the above description and is limited by only the appended claims.

What is claimed is:

1. A method for constructing, by a system capable of communicating a user and including an interface unit configured to receive data from the user and display a position space, an information structure for managing a knowledge information system and searching information from the information structure, the method comprising:
receiving data from the user through the interface unit, generating an information object including the data, arranging the generated information object at a predetermined location of a 2D position space including the information structure, and displaying the position space through the interface unit;
setting, by the user, positional information representing a relative position of the generated information object in the position space, and association information representing a connection relationship between the generated information object and another information object, through the interface unit, arranging the generated information object in the information structure, and displaying the position space through the interface unit;
arranging, by the user, a duplicated structure at the predetermined location of the position space and displaying the position space through the interface unit when a partial or the entire structure of another information structure from another position space is duplicated, through the interface unit;
setting, by the user, positional information representing a relative position of the duplicated structure in the position space from the another position space, and association information representing a connection relationship between an information object included in the duplicated structure from the another position space and the information object of the information structure, arranging the information object included in the structure duplicated from the another position space in the information structure, and displaying the position space through the interface unit, through the interface unit;
arranging the information object included in the structure duplicated from the another position space in the information structure and thereafter, tagging user information in which the another information structure is constructed in the another position space to the information structure; and
searching, by the user, when two or more associated search words are input, an information structure including information objects corresponding to input search words, respectively and in which the information objects corresponding to the input search words, respectively have a similar association as the search words, and displaying the search result, through the interface unit,
wherein the information structure is an information aggregate including a plurality of information objects dimensionally arranged in the position space and selectively connected to each other.

2. A method for constructing, by a system capable of communicating a user and including an interface unit configured to receive data from the user and display a position space, an information structure for managing a knowledge information system and searching information from the information structure, the method comprising:
receiving data from the user through the interface unit, generating an information object including the data, arranging the generated information object at a predetermined location of an nD (n is a natural number of 3 or more) position space including the information structure, and displaying the position space through the interface unit;
setting, by the user, positional information representing a relative position of the generated information object in the position space, and association information representing a connection relationship between the generated information object and another information object, through the interface unit, arranging the generated information object in the information structure, and displaying the position space through the interface unit;
arranging, by the user, a duplicated structure at the predetermined location of the position space and displaying the position space through the interface unit when a partial or the entire structure of another information structure from another position space is duplicated, through the interface unit;
setting, by the user, positional information representing a relative position of the duplicated structure in the position space from the another position space, and association information representing a connection relationship between an information object included in the duplicated structure from the another position space and the information object of the information structure, arranging the information object included in the structure duplicated from the another position space in the information structure, and displaying the position space, through the interface unit;
arranging the information object included in the structure duplicated from the another position space in the information structure and thereafter, tagging user information in which the another information structure is constructed in the another position space to the information structure; and
searching, by the user, when two or more associated search words are input, an information structure including information objects corresponding to input search words, respectively and in which the information objects corresponding to the input search words, respectively have a similar association as the search words, and displaying the search result through the interface unit, through the interface unit,
wherein the information structure is an information aggregate including a plurality of information objects dimensionally arranged in the position space and selectively connected to each other.

3. The method of claim 1 or 2, further comprising:
performing, when any one command of deletion, positional change, association change, and data modification of any one information object included in the information structure is input from the user through the interface unit, any one of the deletion, the positional change, the association change, and the data modification of any one information object according to the command to update the information structure.

4. The method of claim 1 or 2, further comprising:
selecting, by the user, any one information object included in the information structure through the interface unit and additionally generating another position space commonly including the selected information object and subordinate to a location of the selected information object in the position space.

5. The method of claim 1 or 2, wherein
a position space including a predetermined information structure is divided into a position accessible by only the user, a position space accessible by only another user, and a position space accessible by all users including the user and another user.

6. The method of claim 1 or 2, wherein
a connection relationship between a predetermined information object and another information object is represented by a connection line for connecting the predetermined information object and another information object to each other.

7. The method of claim 1 or 2, wherein
the displaying of the search result through the interface unit includes analyzing association information between input search words and information objects corresponding thereto, respectively and when the input search words and the information objects corresponding thereto, respectively are directly connected to each other or directly connected via another information object within a predetermined limited range, searching an information structure having a similar association as an input search word.

8. The method of claim 1 or 2, wherein
when two or more search words are vertically associated with each other, the positional information of the information objects corresponding to the input search words, respectively is analyzed to search only an information structure in which an information object corresponding to a relatively upper-level search word is positioned above an information object corresponding to a relatively lower-level search word as an information structure having a similar association as the input search word.

9. The method of claim 1 or 2, wherein
when two or more search words are horizontally associated with each other, the positional information of the information objects corresponding to the input search words, respectively is analyzed and the information objects corresponding to the input search words, respectively are searched as the information structure having the similar association as the input search word when the information objects corresponding to the input search words, respectively are directly connected to each other or directly connected through another information object via another information object within a predetermined range even though input orders of the search words and a connection order of the information objects are different from each other.

10. The method of claim 1 or 2, wherein
the displaying of the search result through the interface unit includes,
receiving two or more search words from the user through the interface unit;
selecting, by the user, a restriction of at least one of a pattern, an order, and a distance of the association among the information objects corresponding to two or more search words, respectively, through the interface unit; and
searching an information structure including the information objects corresponding to the input search words, respectively and having an association corresponding to any one restriction among a pattern, an order, and a distance of the information objects corresponding to the input search words, respectively selected by the user and displaying the search result through the interface unit, and
the pattern of the association includes a horizontal pattern, a vertical pattern, and a complex pattern having horizontal and vertical patterns.

11. The method of claim 1 or 2, wherein
searching and displaying, when two or more search words are input from the user through the interface unit, an information structure in which at least some of the information objects corresponding to the input search words, respectively coincide with the input search word.

12. A system for constructing an information structure including a plurality of information objects dimensionally arranged in a 2D position space and selectively connected to each other, and searching information from the information structure to manage data, the system comprising:
an interface unit configured to communicate with a user and receive data from the user;
a control unit configured to generate an information object including the data by receiving the data through the interface unit and arrange the generated information object in a position space including the information structure; and
a storage unit configured to store one or more information structures including the information structure with the generated information object,
wherein the user interface unit is configured to receive positional information and association information of the generated information object from the user,
the control unit is configured to arrange the generated information object in the information structure by referring to the positional information and association information of the generated information object,
the interface unit is also configured to allow the user to replicate a part or the entirety of another information structure from another position space,
the control unit is configured to, when a partial or the entire structure of another information structure from another position space is duplicated, through the interface unit, set, by the user, positional information representing a relative position of the duplicated structure in the position space from the another position space, and association information representing a connection relationship between an information object included in the duplicated structure from the another position space and the information object of the information structure, arrange the information object included in the structure duplicated from the another position space in the information structure, tag user information in which the another information structure is constructed in the another position space to the information structure, and display the position space through the interface unit,
the interface unit is also configured to receive two or more associated search words from the user, and
the control unit is also configured to search an information structure including information objects corresponding to input search words, respectively and in which the information objects corresponding to the input search words, respectively have a similar association as the search word, from the storage unit to display the search result to the user through the interface unit.

13. A system for constructing an information structure including a plurality of information objects dimensionally arranged in an nD (n is a natural number of 3 or more) position space and selectively connected to each other, and searching information from the information structure, the system comprising:
an interface unit configured to communicate with a user and receive data from the user;
a control unit configured to generate an information object including the data by receiving the data through the interface unit and arrange the generated information object in a position space including the information structure; and
a storage unit configured to store one or more information structures including the information structure with the generated information object,
wherein the user interface unit is configured to receive positional information and association information of the generated information object from the user,
the control unit is configured to arrange the generated information object in the information structure by referring to the positional information and association information of the generated information object,
the interface unit is also configured to allow the user to replicate a part or the entirety of another information structure from another position space,
the control unit is configured to, when a partial or the entire structure of another information structure from another position space is duplicated, through the interface unit, set, by the user, positional information representing a relative position of the duplicated structure in the position space from the another position space, and association information representing a connection relationship between an information object included in the duplicated structure from the another position space and the information object of the information structure, arrange the information object included in the structure duplicated from the another position space in the information structure, tag user information in which the another information structure is constructed in the another position space to the information structure, and display the position space through the interface unit,
the interface unit is also configured to receive two or more associated search words from the user, and
the control unit is also configured to search an information structure including information objects corresponding to input search words, respectively and in which the information objects corresponding to the input search words, respectively have a similar association as the search word, from the storage unit to display the search result to the user through the interface unit.

14. The system of claim 12 or 13, wherein
the control unit is also configured to store, in generating, an information object, data to be included in the generated information object in a third-party server provided to communicate with the system through a network and store positional information and association information of the generated information object in the storage unit.
